(19) United States
(12) Patent Application Publication
(10) Pub. No.: US 2023/0418603 A1
(43) Pub. Date: Dec. 28, 2023

(54) System and Method for Securing Nonvolatile Memory for Execute-in-Place

(71) Applicant: Silicon Laboratories Inc., Austin, TX (US)

(72) Inventors: Marius Grannaes, Baerum (NO); Joshua Norem, Austin, TX (US)

(21) Appl. No.: 17/846,587

(22) Filed: Jun. 22, 2022

(51) Int. Cl. G06F 9/30; G06F 9/38

(52) U.S. Cl. CPC G06F 9/30036; G06F 9/3816; G06F 9/3004; G06F 9/30112

(57) ABSTRACT

A system for securing the contents of an external nonvolatile memory associated with a main processing device is disclosed. The system stores additional information associated with each cache line in the nonvolatile memory. In some embodiments, this additional information comprises a NONCE (number used once) and a MAC (Message Authentication Code). When the main processing device reads a cache line from the nonvolatile memory, the NONCE, address and data from the cache line are used to generate a MAC, which is then compared to the MAC stored in the nonvolatile memory. If the MACs match, the cache line is stored in the on-board cache of the main processing device. If the MACs do not match, a countermeasure may be implemented. The use of a NONCE addresses an information leakage issue that is present when stream ciphers, such as AES-CTR or AES-GCM, are used in data storage applications.

### FIELD

This disclosure describes systems for securing the contents of an external nonvolatile memory.

### BACKGROUND

System on Chip (SoC) and other similar devices are created by disposing a processing unit, its instructions and other functions within a single die. In some cases, the processing unit may be an ARM-based processor, although other processors may be used. Further, in some embodiments, the instructions are disposed within a rewritable nonvolatile memory (NVM), such as a FLASH memory.

In certain embodiments, it may be beneficial to have the nonvolatile memory disposed in a separate die from the processing unit. This may be due to differences in fabrication technologies or other factors. In these embodiments, the processing unit must access the external nonvolatile memory to obtain the instructions to be executed.

When attempting true execution in place from external memories, the system needs to be efficient when fetching cache lines (typically 128 bits) from FLASH memory in an essentially random access regime. The system has no knowledge of the future, for example when fetching line N, it is unknown when line N+1 will be fetched or what address will be required next.

However, in this configuration, the instructions to be executed by the processing unit may be observed or altered by a hacker or bad actor as it is transmitted from the FLASH memory to the SoC. Many systems using external nonvolatile memory provide no protection at all, relying on the difficulty of accessing the interconnect to prevent attacks on the bus. Some systems may encrypt the flash data using Advanced Encryption Standard: Counter Mode (AES-CTR). While this does prevent reading of the data and is efficient, it does very little to protect against an attacker modifying the data. A property of CTR is that when a bit is flipped in the cipher text, it is flipped in the plain text allowing attackers to arbitrarily flip bits in the data stream. Some more recent devices support the use of Advanced Encryption Standard: Efficient and Compact Subgroup Trace Representation (AES-XTS). This scheme is much less efficient in this particular use case than CTR and while it does provide more protection against data manipulation, it provides little to no protection against fault injection attacks.

Therefore, it would be beneficial if there were a system that could offer data protection while not significantly affecting performance and latency.

### SUMMARY

A system for securing the contents of an external nonvolatile memory associated with a main processing device is disclosed. The system stores additional information associated with each cache line in the nonvolatile memory. In some embodiments, this additional information comprises a NONCE (number used once) and a MAC (Message Authentication Code). When the main processing device reads a cache line from the nonvolatile memory, the NONCE, address and data from the cache line are used to generate a MAC, which is then compared to the MAC stored in the nonvolatile memory. If the MACs match, the cache line is stored in the on-board cache of the main processing device. If the MACs do not match, a countermeasure may be implemented. The use of a NONCE addresses an information leakage issue that is present when stream ciphers, such as AES-CTR or AES-GCM, are used in data storage applications.

According to one embodiment, an integrated circuit for securing content on an external writable nonvolatile memory is disclosed. The integrated circuit comprises an address translation circuit, wherein the address translation circuit receives a CPU address as an input and generates a memory address as an output; a NONCE generator to generate a NONCE, wherein the NONCE and either the memory address or the CPU address are used to create an initialization vector; and an encryption module, wherein the encryption module utilizes a key, the initialization vector and a plaintext cache line to be written to the external writable nonvolatile memory to generate an encrypted cache line and a message authentication code (MAC); and wherein for each plaintext cache line, an encrypted data structure is stored in the external writable nonvolatile memory, wherein the encrypted data structure comprises the nonce, the encrypted cache line and a value derived from the MAC, referred to as a stored MAC. In some embodiments, the NONCE generator is a pseudorandom number generator. In some embodiments, the NONCE generator is a counter. In some embodiments, the integrated circuit comprises a MAC compression circuit, wherein the MAC generated by the encryption module is provided to the MAC compression circuit, and the value derived from the MAC is generated, wherein the value derived from the MAC has fewer bits than the MAC. In certain embodiments, the NONCE and the stored MAC comprise 8 bytes or less and the plaintext cache line comprises 32 bytes or more. In some embodiments, the encryption module utilizes an AEAD (Authenticated Encryption with Associated Data) algorithm. In certain embodiments, the AEAD algorithm comprises an AES-GCM or ChaCha20-Poly 1305 encryption algorithm. In some embodiments, the NONCE and the memory address are used to create the initialization vector. In some embodiments, the NONCE and the CPU address are used to create the initialization vector.

According to another embodiment, an integrated circuit for retrieving secured content from an external writable nonvolatile memory is disclosed. The integrated circuit comprises a cache and a cache controller, wherein the cache controller provides a CPU address of a plaintext cache line; an address translation circuit, wherein the address translation circuit receives the CPU address as an input and generates a memory address as an output to the external writable nonvolatile memory, wherein an encrypted data structure is disposed at the memory address in the external writable nonvolatile memory, wherein the encrypted data structure comprises a NONCE, a stored MAC and an encrypted cache line; and a decryption module, wherein the decryption module utilizes a key, an initialization vector and the encrypted cache line to generate the plaintext cache line and a calculated message authentication code (MAC), wherein the initialization vector is a function of the NONCE and either the memory address or the CPU address. In some embodiments, the integrated circuit comprises a MAC compression circuit, wherein the calculated MAC is provided to the MAC compression circuit, and a value derived from the calculated MAC is generated, wherein the value derived from the calculated MAC has fewer bits than the MAC and is equal in length to the stored MAC. In certain embodiments, the value derived from the calculated MAC is compared to the stored MAC. In some embodiments, if the compare is successful, the plaintext cache line is stored in the cache. In some embodiments, if the compare is unsuccessful, a countermeasure is performed. In certain embodiments, the countermeasure is selected from the group consisting of: resetting a processing unit disposed in the integrated circuit; discarding the encrypted data structure and retrying; and notifying other software or hardware of a potential tamper event. In certain embodiments, the NONCE and the stored MAC comprise 8 bytes or less and the plaintext cache line comprises 32 bytes or more. In some embodiments, the encryption module utilizes an AEAD (Authenticated Encryption with Associated Data) algorithm. In certain embodiments, the AEAD algorithm comprises an AES-GCM or ChaCha20-Poly 1305 encryption algorithm. In some embodiments, the NONCE and the memory address are used to create the initialization vector. In some embodiments, the NONCE and the CPU address are used to create the initialization vector.

### BRIEF DESCRIPTION OF THE DRAWINGS

For a better understanding of the present disclosure, reference is made to the accompanying drawings, in which like elements are referenced with like numerals, and in which:

FIG. 1 shows a main processing device and an associated external nonvolatile memory;

FIG. 2 shows the organization of data in the cache and in the external nonvolatile memory;

FIG. 3 is a block diagram of the NVM write circuit according to one embodiment; and

FIG. 4 is a block diagram of the NVM read circuit according to one embodiment.

### DETAILED DESCRIPTION

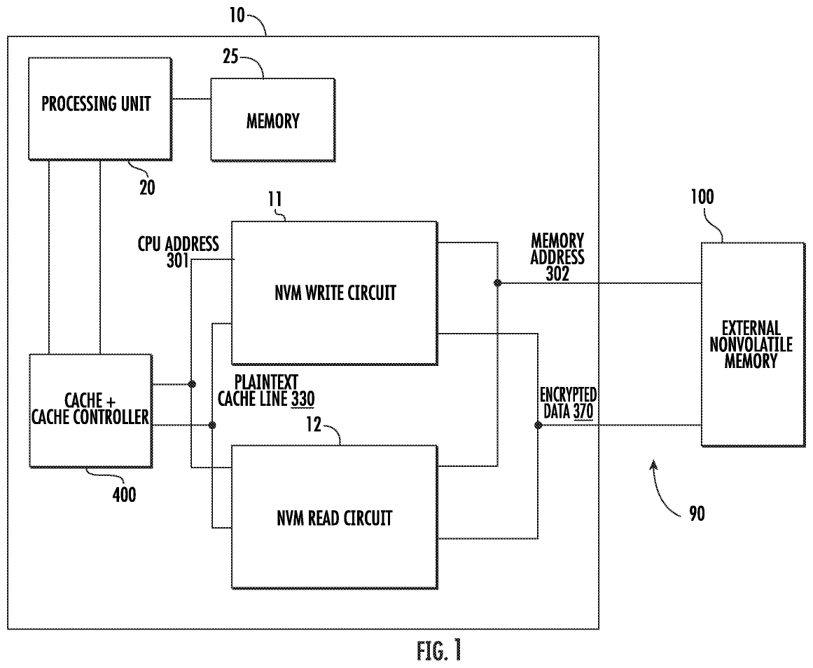

FIG. 1 shows a block diagram with a main processing device 10 and an associated external nonvolatile memory 100. The main processing device 10 may include an embedded processing unit 20, an associated memory 30 and a cache memory 400 with an associated cache controller. In certain embodiments, the main processing device 10 may be fabricated using 22 nm technology. In some embodiments, a smaller geometry may be used. This choice allows a maximum number of transistors, while minimizing power consumption.

The external nonvolatile memory 100 may be fabricated using an older technology, such as 40 nm or 90 nm. These technologies are better adapted to nonvolatile memories, such as FLASH memories.

Additionally, an interface 90 may be used to communicate between the two devices. The interface 90 may include one or more memory data signals. In some embodiments, the memory data signals are bi-directional. In other embodiments, the memory data signals may be uni-directional. In many embodiments, the width of the memory data signals may be between 1 and 8 bits, although other widths are possible. The interface 90 may also include memory address signals. In certain embodiments, the memory address signals and the memory data signals may be multiplexed on the same physical connections.

To communicate with the external nonvolatile memory 100, the main processing device 10 also includes an NVM write circuit 11, which is used to convert plaintext cache lines into encrypted data structures that are written to the external nonvolatile memory 100. The main processing device 10 also includes an NVM read circuit 12, which is used to decrypt the encrypted data structures from the external nonvolatile memory 100 and write plaintext cache lines in the cache memory 400.

As described above, it is beneficial to protect the contents of the external nonvolatile memory 100. In the present disclosure, this is done by including a stored MAC with each cache line. By using a stored MAC, the contents of the external nonvolatile memory 100 can be secured. Further, because the stored MAC is associated with a single cache line, a determination as to the integrity of the cache line can be done immediately after it is retrieved from the external nonvolatile memory 100.

Additionally, it may be beneficial to utilize a NONCE, which may be a random number. The use of a NONCE helps to ensure that the probability that writes to the same address will use the same initialization vector (IV) is acceptably small.

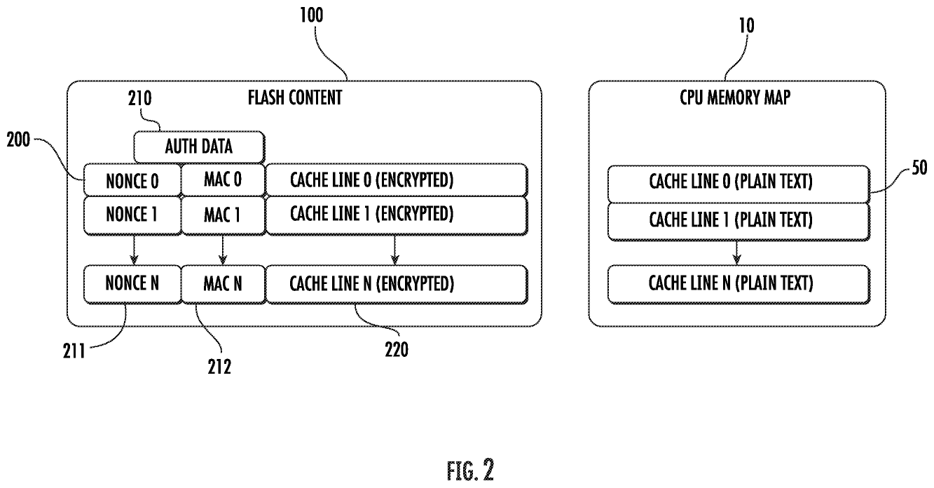

As shown in FIG. 2, the external nonvolatile memory 100 is organized in encrypted data structures 200, where each encrypted data structure 200 includes authentication information 210 and the corresponding encrypted cache line 220. When this encrypted data structure 200 is read from the external nonvolatile memory 100, it is decrypted and validated and stored in an on-board cache memory 400 of the main processing device 10 as a plaintext cache line 50.

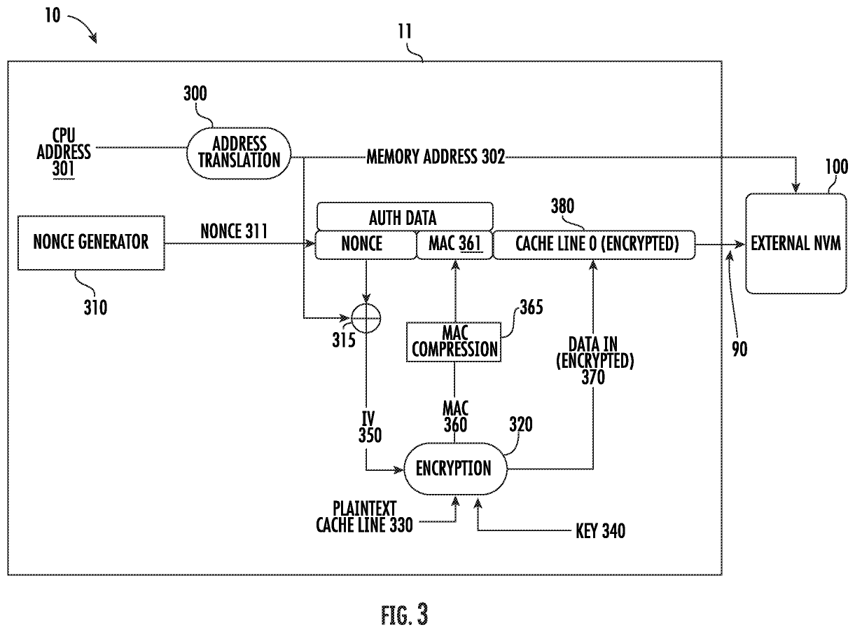

The authentication information 210 may include a NONCE 211. The NONCE is a random number that is used to generate the initialization vector (IV) for the encryption module 320 (see FIG. 3) when the encrypted cache line 220 is generated. This NONCE 211 may be generated by the main processing device 10 when data is being written to the external nonvolatile memory 100. Because the NONCE 211 is also stored in the external nonvolatile memory 100, there is no need for the main processing device 10 to remember the NONCE 211 that was used for each cache line.

Additionally, the authentication information 210 includes a value that is derived from the Message Authentication Code (MAC). The MAC is generated by the encryption module 320 (see FIG. 3) when the encrypted cache line 220 is written to the external nonvolatile memory 100. The stored MAC 212 is derived from the MAC and, in some embodiments, contains fewer bits than the MAC.

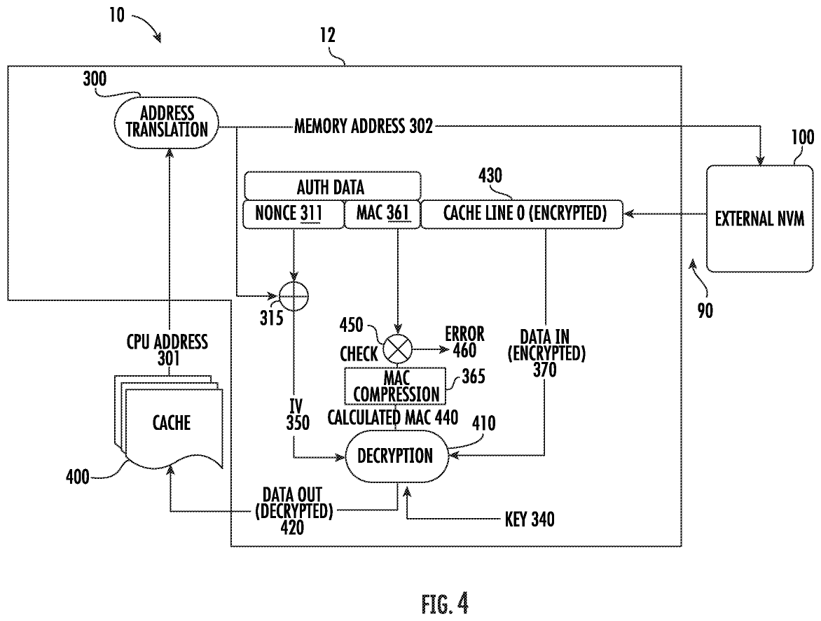

FIG. 3 shows a block diagram of the portion of the main processing device 10 which writes cache lines to the external nonvolatile memory 100, referred to as the NVM write circuit 11. FIG. 4 shows a block diagram of the portion of the main processing device 10 which fetches cache lines from the external nonvolatile memory 100, referred to as the NVM read circuit 12. Each of the blocks in this figure represent circuitry that may be implemented using transistors, logic gates and storage elements and is disposed in an integrated circuit.

As shown in FIG. 3, the main processing device 10 includes an NVM write circuit 11. The NVM write circuit 11 includes an address translation circuit 300. The address translation circuit 300 converts CPU addresses 301 used by the processing unit into the memory addresses 302 that are used for the external nonvolatile memory 100. This is necessary because the compilers and the code that they generate are not aware of the authentication information 210, and therefore, cannot know the memory addresses 302 used to store the data in the external nonvolatile memory 100. For example, a cache line may be 64 bytes, but when stored in the external nonvolatile memory, the encrypted cache line may be 72 bytes, when the authentication information is appended to it. The address translation circuit 300 may be a lookup table, or combinational logic that determines the memory address 302 based on the CPU address 301. The actual implementation of the address translation circuit 300 is not limited by this disclosure. The CPU address may be provided to the address translation circuit 300 by the cache memory 400 or its associated cache controller. In other embodiments, the CPU address may be provided directly from the processing unit 20.

The NVM write circuit 11 also includes NONCE generator 310. In some embodiments, the NONCE generator 310 may be a pseudorandom number generator. In other embodiments, the NONCE generator 310 may be counter that increments by a constant value. Again, the actual implementation of the NONCE generator 310 is not limited by this disclosure. The output of the NONCE generator 310 is a NONCE 311. The length of the NONCE 311 may be any suitable length, such as 32 bits. In other embodiments, the NONCE 311 may be shorter than 32 bits.

The NVM write circuit 11 also include an encryption module 320. The encryption module 320 may utilize any suitable encryption algorithm. In certain embodiments, the encryption algorithm may be Advanced Encryption Standard-Galois Counter Mode (AES-GCM). In another embodiment, the encryption algorithm may be ChaCha20-Poly 1305. In another embodiment, the encryption algorithm may be AES-Counter with CBC-MAC (AES-CCM) In other embodiments, any symmetric cypher that supports encryption and authentication may be utilized.

The encryption module 320 utilizes three inputs. The first is the plaintext cache line 330 to be encrypted. The plaintext cache line 330 may be any suitable length. In some embodiments, the plaintext cache line 330 may be at least 16 bytes. In certain embodiments, its length may be at least 32 bytes. In certain embodiments, its length may be between 64 and 256 bytes. In certain embodiments, the length may be smaller, but the storage efficiency of the external nonvolatile memory 100 may be compromised. The plaintext cache line 330 may be provided by the cache memory 400 or the memory 25.

The second input is the key 340. In certain embodiments, the key 340 is known only to this particular main processing device and every main processing device has a unique key. In certain embodiments, the key 340 is stored in a secure storage which is not accessible externally. The key 340 may be any suitable length, such as 128 bits, 256 bits, or another length.

Finally, the third input is an initialization vector (IV) 350. The IV 350 is preferably unique to each cache line. Further, this value preferably is different if this cache line is written at a later time. In certain embodiments, the IV 350 is generated by adding the NONCE 311 and the memory address 302 using adder 315. In another embodiment, the IV 350 is generated by adding the NONCE 311 and the CPU address 301. Further, while these values may be added, it is understood that any deterministic function may be performed using these two values. For example, the two values may be subtracted, multiplied or otherwise combined. In other words, the IV 350 is a function of the NONCE 311 and either the memory address 302 or the CPU address 301. The length of the IV 350 is determined by the underlying cipher being used. In some embodiments, it may be 128 bits or 256 bits.

Using these three inputs, the encryption module 320 generates encrypted data 370 that will be written to the external nonvolatile memory 100. The encryption module 320 also generates a message authentication code (MAC) 360. The underlying algorithm determines the operations that are performed by the encryption module 320. For example, the AES-GCM specification defines exactly how these inputs are used to generate encrypted data 370 and the MAC 360. Similarly, ChaCha20-Poly 1305 also has a specification that defines the operations performed to generate these outputs. Any suitable AEAD (Authenticated Encryption with Associated Data) algorithm may be used.

The NONCE 311 (which is plaintext), the stored MAC 361 and the encrypted data 370 may then all be written to a data out register 380. The contents of the data out register 380 are then written to the external nonvolatile memory 100. In certain embodiments, the NONCE 311, the stored MAC 361 and the encrypted data 370 are stored in the data out register 380 in that order. In another embodiment, the stored MAC 361 may be written last.

In one embodiment, the MAC 360, as generated by the encryption module 320, which may be 128 bits although other lengths are possible, is saved in the data out register 380 and transmitted over the interface 90. Thus, in this embodiment, the MAC 360 and the stored MAC 361 may be the same value and the same length. In certain embodiments, it may be beneficial to transmit a truncated or encoded version of the MAC 360 to minimize the impact of sending and storing the entire MAC 360. In one embodiment, only N bits of the MAC are transmitted. These may be the last N bits of the MAC 360, the first N bits of the MAC 360, or some subset of N bits. In another embodiment, the MAC 360, which may be 128 bits, is subject to an encoding scheme that results in N bits. In some embodiments, N may be a 16, 32, 48 or 64 bits. Of course, other lengths may also be used. Thus, in these embodiments, a MAC compression circuit 365 is used. The MAC compression circuit 365 receives the MAC 360 from the encryption module 320 as an input and generates a shorter value that is derived from the MAC 360. The shortened value may be any of the embodiments described above. This shortened value then becomes the stored MAC 361. Thus, in all embodiments, a value that is derived from the MAC 360 is stored in the external nonvolatile memory 100. This value is referred to as the stored MAC 361.

In certain embodiments, the authentication information 210 may be less than or equal to 8 bytes in length. For example, in one embodiment, the NONCE 311 and stored MAC 361 may each be 4 bytes long. In another embodiment, the NONCE 311 may be smaller than 4 bytes, while the stored MAC 361 is larger than 4 bytes. In certain embodiments, to maximize storage efficiency, the authentication information 210 may be as small as 4 bytes. In certain embodiments, such as when large cache lines are used, the authentication information may be more than 8 bytes.

Thus, FIG. 3 shows a NVM write circuit 11 that processes one cache line at a time, generating encrypted data 370, a stored MAC 361 and a NONCE 311. The encrypted data 370, the stored MAC 361 and the NONCE 311 are then written to the external nonvolatile memory 100.

Thus, using the NVM write circuit 11 as described above, the plaintext cache line 50 shown in FIG. 2 is converted into the encrypted data structure 200, which includes an encrypted cache line 220, a NONCE 211 and a stored MAC 212.

Thus, the present disclosure describes a system and method for securing content in an external nonvolatile memory 100. The system includes an NVM write circuit 11 that organizes the nonvolatile memory into a plurality of encrypted data structures 200, wherein each encrypted data structure comprises authentication information 210 and a corresponding encrypted cache line 220. The authentication information 210 includes the stored MAC 212 associated with the encrypted cache line, and also includes a NONCE 211 which was used to generate the initialization vector used to encrypt the encrypted cache line 220.

As shown in FIG. 4, the main processing device 10 also includes a NVM read circuit 12. The NVM read circuit 12 interfaces with the cache memory 400. The cache memory 400 may be any level cache, such as an L1, L2 or L3 cache. In certain embodiments, the cache memory 400 is the last level cache. For example, if the main processing device 10 includes 3 levels of cache, the cache memory 400 would be the Level-3 (L3) cache. If the main processing device includes 2 levels of cache, the cache memory 400 would be the Level-2 (L2) cache. If the main processing device 10 includes only 1 level of cache, the cache memory 400 would be a Level-1 (L1) cache. The length of the cache line in the cache memory 400 determines the length of the cache line in the external nonvolatile memory 100.

The NVM read circuit 12 includes many of the same components used in the NVM write circuit 11. In certain embodiments, these components may be shared between the two circuits. In other embodiments, the components are duplicated. Components with the same function have been given identical reference designators.

For example, the NVM read circuit 12 includes an address translation circuit 300, which is identical to that described above. In this embodiment, the input to the address translation circuit 300 may be from the cache memory 400 or the associated cache controller. For example, the cache controller may opt to prefetch a new cache line from the next location in the memory or may fetch a different cache line if a change in the CPU address, caused by a branch or jump instruction, occurred. In all embodiments, the new CPU address is presented to the address translation circuit 300.

As described above, the address translation circuit 300 converts the CPU address 301 into a memory address 302. That memory address 302 is used on the interface 90 to access the external nonvolatile memory 100. In response, the external nonvolatile memory 100 supplies an encrypted data structure. In some embodiments, the encrypted data structure is written to a data in register 430. Since an encrypted data structure may be in excess of 16 bytes, it may take several read cycles from the external nonvolatile memory 100 to read the entire encrypted data structure into the data in register 430.

The decryption module 410 implements the same encryption algorithm used by the encryption module 320 and also requires three inputs. These inputs include the IV 350, the key 340 and the encrypted data 370. Using these inputs, the decryption module 410 generates a calculated MAC 440 and a plaintext cache line 420.

In certain embodiments, the encrypted data structure begins with the NONCE 311. In this way, as soon as the first part of the encrypted data structure is read into the data in register 430, the IV 350 can be computed, using the NONCE 311 and either the CPU address 301 or the memory address 302. As described above, in some embodiments, the NONCE 311 and the memory address 302 are added using adder 315 to create the IV 350. In other embodiments, a different function is performed to create the IV 350.

Thus, after the first part of the encrypted data structure is read, the decryption module 410 has the IV 350 and the key 340, and is able to begin decrypting the incoming encrypted cache line immediately.

Therefore, in some embodiments, the NONCE 311 is stored at the beginning of the encrypted data structure. This placement allows the process of reading the encrypted cache line from the external nonvolatile memory (which may require several read cycles) to be overlapped with the decryption of that encrypted cache line.

As the decryption module 410 is decrypting the incoming data, it is also generating a calculated MAC 440. After the entire encrypted cache line has been decrypted, the calculated MAC 440 may be subjected to the same process that reduces its length as was done in the NVM write circuit 11 using the MAC compression circuit 365. The calculated MAC 440, or the reduced length MAC, is compared to the stored MAC 361 that was stored in the external nonvolatile memory 100 as part of the encrypted data structure. This comparison may be done using comparator 450.

If the comparison is successful, the plaintext cache line 420 is added to the cache memory 400. If the comparison is unsuccessful, an error 460 is detected. In response to the error 460, several different countermeasures may be taken. In one embodiment, the countermeasure may comprise resetting the processing unit 20. In another embodiment, the countermeasure may be to discard the incoming data and retry the fetch operation. In another embodiment, the NVM read circuit 12 may notify other software or hardware of a potential tamper event to allow for disposition.

The present system has many advantages. In certain embodiments, the present system is a modified version of AES-GCM which solves two limitations of GCM. First, the confidentiality of GCM in storage applications is weak due to properties of the underlying AES-CTR encryption. To correct for this, the GCM IV in the present application is comprised of the address of data being fetched and a small random NONCE value which is written to the external nonvolatile memory. The random value ensures that the probability writes to the same address use the same NONCE (and thus the same IV) is acceptably small. Given that writes are infrequent and not easily provokable, in a well designed system, only a small number of bits is needed.

The second issue with standard GCM is that the MAC is 16 bytes, which is excessively large when dealing with cache line that are not very long, such as less than 256 bytes. In standard GCM, the MAC length is large to account for a number of threats that are not present in the present system. Specifically, the rate at which an attacker can attempt to guess the MAC is fundamentally limited by the speed of the part and, even in the most optimal situation, will not exceeded 1 million attempts a second. Given that, the size of the MAC can be reduced considerably.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An integrated circuit for securing content on an external writable nonvolatile memory, comprising:
an address translation circuit, wherein the address translation circuit receives a CPU address as an input and generates a memory address as an output;
a NONCE generator to generate a NONCE, wherein the NONCE and either the memory address or the CPU address are used to create an initialization vector; and
an encryption module, wherein the encryption module utilizes a key, the initialization vector and a plaintext cache line to be written to the external writable nonvolatile memory to generate an encrypted cache line and a message authentication code (MAC); and
wherein for each plaintext cache line, an encrypted data structure is stored in the external writable nonvolatile memory, wherein the encrypted data structure comprises the nonce, the encrypted cache line and a value derived from the MAC, referred to as a stored MAC.

2. The integrated circuit of claim 1, wherein the NONCE generator is a pseudorandom number generator.

3. The integrated circuit of claim 1, wherein the NONCE generator is a counter.

4. The integrated circuit of claim 1, further comprising a MAC compression circuit, wherein the MAC generated by the encryption module is provided to the MAC compression circuit, and the value derived from the MAC is generated, wherein the value derived from the MAC has fewer bits than the MAC.

5. The integrated circuit of claim 1, wherein the NONCE and the stored MAC comprise 8 bytes or less and the plaintext cache line comprises 32 bytes or more.

6. The integrated circuit of claim 1, wherein the encryption module utilizes an AEAD (Authenticated Encryption with Associated Data) algorithm.

7. The integrated circuit of claim 6, wherein the AEAD algorithm comprises an AES-GCM or ChaCha20-Poly 1305 encryption algorithm.

8. The integrated circuit of claim 1, wherein the NONCE and the memory address are used to create the initialization vector.

9. The integrated circuit of claim 1, wherein the NONCE and the CPU address are used to create the initialization vector.

10. An integrated circuit for retrieving secured content from an external writable nonvolatile memory, comprising:
a cache and a cache controller, wherein the cache controller provides a CPU address of a plaintext cache line;
an address translation circuit, wherein the address translation circuit receives the CPU address as an input and generates a memory address as an output to the external writable nonvolatile memory, wherein an encrypted data structure is disposed at the memory address in the external writable nonvolatile memory, wherein the encrypted data structure comprises a NONCE, a stored MAC and an encrypted cache line; and
a decryption module, wherein the decryption module utilizes a key, an initialization vector and the encrypted cache line to generate the plaintext cache line and a calculated message authentication code (MAC), wherein the initialization vector is a function of the NONCE and either the memory address or the CPU address.

11. The integrated circuit of claim 10, further comprising a MAC compression circuit, wherein the calculated MAC is provided to the MAC compression circuit, and a value derived from the calculated MAC is generated, wherein the value derived from the calculated MAC has fewer bits than the MAC and is equal in length to the stored MAC.

12. The integrated circuit of claim 11, wherein the value derived from the calculated MAC is compared to the stored MAC.

13. The integrated circuit of claim 12, wherein if the compare is successful, the plaintext cache line is stored in the cache.

14. The integrated circuit of claim 12, wherein if the compare is unsuccessful, a countermeasure is performed.

15. The integrated circuit of claim 14, wherein the countermeasure is selected from the group consisting of:
resetting a processing unit disposed in the integrated circuit; discarding the encrypted data structure and retrying; and notifying other software or hardware of a potential tamper event.

16. The integrated circuit of claim 10, wherein the NONCE and the stored MAC comprise 8 bytes or less and the plaintext cache line comprises 32 bytes or more.

17. The integrated circuit of claim 10, wherein the decryption module utilizes an AEAD (Authenticated Encryption with Associated Data) algorithm.

18. The integrated circuit of claim 17, wherein the AEAD algorithm comprises an AES-GCM or ChaCha20-Poly 1305 encryption algorithm.

19. The integrated circuit of claim 10, wherein the NONCE and the memory address are used to create the initialization vector.

20. The integrated circuit of claim 10, wherein the NONCE and the CPU address are used to create the initialization vector.
